(19) United States
(12) Patent Application Publication
(10) Pub. No.: US 2025/0208966 A1
(43) Pub. Date: Jun. 26, 2025

(54) GENERATION OF OVERCLOCKING PROFILE RECOMMENDATIONS FOR COMPUTING SYSTEMS

(71) Applicant: Advanced Micro Devices, Inc., Santa Clara, CA (US)

(72) Inventors: Ravi Subbannavar, Bangalore (IN); Joshua Taylor Knight, Austin, TX (US); Grant Evan Ley, Eden, UT (US); Jerry Anton Ahrens, JR., Sister Bay, WI (US); Dhavalkumar Dineshbhai Shah, Bangalore (IN); Ganesha Madiyala Shivaram, Bangalore (IN); Abhinay Sharma, Bangalore (IN); William R. Alverson, Austin, TX (US)

(21) Appl. No.: 18/393,662

(22) Filed: Dec. 21, 2023

(51) Int. Cl. G06F 11/30; G06F 16/901; G06F 16/9035

(52) U.S. Cl. CPC G06F 11/3055; G06F 11/3006; G06F 16/901; G06F 16/9035

(57) ABSTRACT

An apparatus and method for efficiently scheduling wavefronts for efficiently increasing computing system performance by using operating settings that exceed the manufacturer's default range of settings. In various implementations, a computing system includes a server that communicates with multiple client devices through a network. The server receives an overclocking request from a client device for an overclocking recommendation profile. The server searches a database that stores multiple overclocking recommendation profiles based on test data generated by multiple system configurations. The server either receives an overclocking recommendation profile from the database or generates an overclocking recommendation profile using one of several hardware-based and software-based systems. The server sends the first overclocking recommendation profile to the client device.

### BACKGROUND

### Description of the Relevant Art

Many users desire to increase the performance of their computing systems such as a desktop computer, a laptop computer, or otherwise. To increase the performance, the user attempts to tune multiple operating settings of the user's computing system such that these settings no longer utilize the manufacturer's default range of settings. Examples of these operating settings are the operating voltages and the operating clock frequencies of one or more cores of a general-purpose processing circuit, the operating voltages and the operating clock frequencies of one or more compute circuits or other subblocks of a parallel data processing circuit, the operating voltages and the operating clock frequencies of one or more memory devices of the memory subsystem, the access timing configurations of the one or more memory devices, and so forth.

Typically, when the user attempts to increase the performance of their computing system, the steps taken are not user friendly and require a lot of time, especially if multiple iterations are performed, and one or more iterations require a reboot operation that is performed followed by reloading a desired application. In addition, the results can still include manufacturer margins in voltages, clock frequencies, and memory device access times, which limits any achieved performance increase. Further, when the user finally achieves the steps of applying higher performance operating settings, the user did not account for the limits of the cooling system or reliability long-term effects on the components of the computing system. Furthermore, the user does not have access to the result data of multiple tests run on the user's particular computing system.

In view of the above, efficient methods and mechanisms for efficiently increasing computing system performance by using operating settings that exceed the manufacturer's default range of settings are desired.

### BRIEF DESCRIPTION OF THE DRAWINGS

FIG. 1 is a generalized block diagram of a computing system that efficiently increases performance of a user's computing system by using operating settings that exceed the manufacturer's default range of settings.

FIG. 2 is a generalized block diagram of a sequence diagram that efficiently increases computing system performance by using operating settings that exceed the manufacturer's default range of settings.

FIG. 3 is a generalized block diagram of another computing system that efficiently increases performance of a user's computing system by using operating settings that exceed the manufacturer's default range of settings.

FIG. 4 is a generalized block diagram of a user interface of an overclocking tool used for efficiently increasing computing system performance by using operating settings that exceed the manufacturer's default range of settings.

FIG. 5 is a generalized block diagram of a method for efficiently increasing computing system performance by using operating settings that exceed the manufacturer's default range of settings.

FIG. 6 is a generalized block diagram of a method for efficiently increasing computing system performance by using operating settings that exceed the manufacturer's default range of settings.

FIG. 7 is a generalized block diagram of a method for efficiently increasing computing system performance by using operating settings that exceed the manufacturer's default range of settings.

FIG. 8 is a generalized block diagram of a method for efficiently increasing computing system performance by using operating settings that exceed the manufacturer's default range of settings.

FIG. 9 is a generalized block diagram of a method for efficiently increasing computing system performance by using operating settings that exceed the manufacturer's default range of settings.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses, systems, and methods are contemplated that efficiently increase performance of a user's computing system by using operating settings that exceed the manufacturer's default range of settings. In various implementations, a computing system includes one or more servers that communicate with multiple client devices through a network. Each of the multiple client devices is a user's computing system such as a desktop computer, a laptop computer, or other. As used herein, the term “overclocking” can also be referred to as “overclocked tuning,” and “automatic overclocked tuning.” Overclocking refers to selecting operating settings for the user's client device that exceed the manufacturer's default range of operating settings to increase performance of the user's client device.

Automatic overclocked tuning (or overclocking) does not include manual steps performed by the user of the client device other than to initiate generating the overclocking request and then to later apply one or more operating settings of a received overclocking recommendation profile to the user's client device. Therefore, the user increases performance of the user's client device without iterative manual steps performed by the user and without the chance that the user causes damage to the client device. Although the term “overclocking” includes the term “clocking”, which refers to an operating clock frequency, a variety of operating settings (or operating parameters) of the client device can be changed to values outside the manufacturer's default range of settings to increase performance of the user's client device.

Circuitry of a processing circuit of the user's client device executes instructions of an application such as an overclocking tool. When executing the instructions of the overclocking tool, the processing circuit generates an overclocking request based on user input. The user's client device generates the overclocking request based on user input to retrieve an overclocking recommendation profile that includes recommended values of one or more operating settings that exceed the manufacturer's default range of settings. The overclocking request includes system configuration parameters of the user's client device. The user's client device sends the overclocking request, via the network, to a server of the one or more servers. In some implementations, the server searches stored data (“a database”) that stores multiple overclocking recommendation profiles based on test data generated by multiple system configurations. The server receives an overclocking recommendation profile from the database and sends the overclocking recommendation profile to the user's client device via the network.

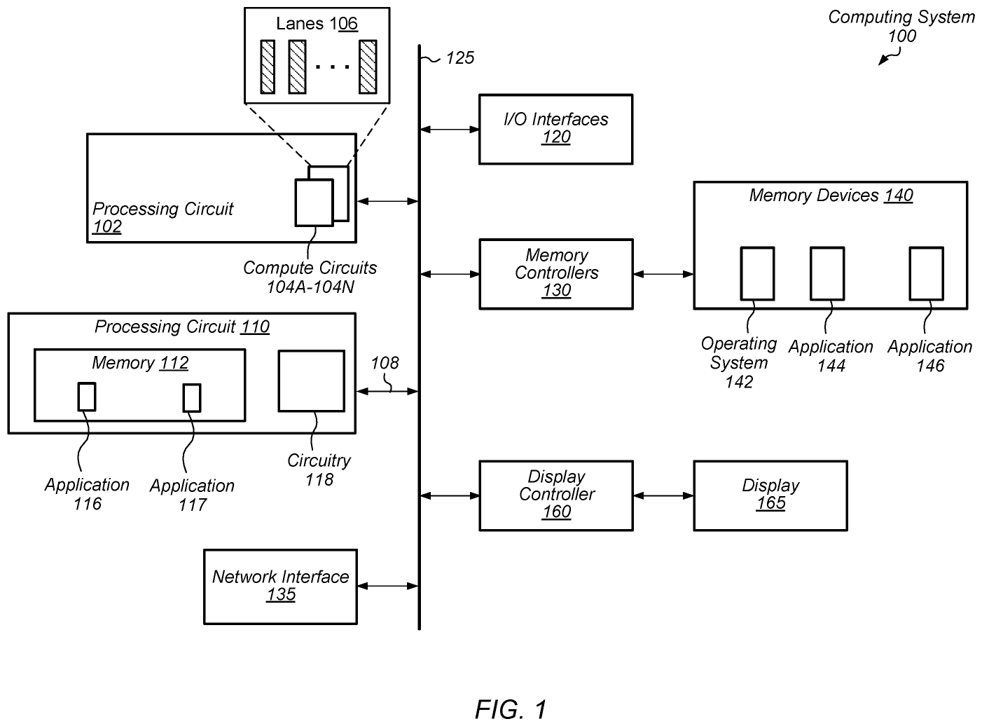

In other implementations, the server sends a request to another computing device that generates the overclocking recommendation profile and then returns the generated results. In yet other implementations, the server or the other computing device performs simulations using system configuration parameters of the user's client device to generate the overclocking recommendation profile. It is possible and contemplated that the server or the other computing device executes a machine learning data model, such as one of a variety of types of a neural network, to generate the overclocking recommendation profile. Through use of the overclocking tool, the user selects and updates one or more of the operating settings of the user's client device with corresponding recommended operating settings from the overclocking recommendation profile. By doing so, the user increases performance of the user's client device without iterative manual steps performed by the user and without the chance that the user causes damage to the client device. Further description of the values included in the operating settings, the system configuration parameters, and the overclocking recommendation profile in addition to further details of these techniques to efficiently increase performance of a user's computing system by using operating settings that exceed the manufacturer's default range of settings are provided in the following description of FIGS. 1-9.

Turning now to FIG. 1, a generalized diagram is shown of an implementation of a computing system 100 that efficiently increases computing system performance by using operating settings that exceed the manufacturer's default range of settings. In an implementation, computing system 100 includes at least processing circuits 102 and 110, input/output (I/O) interfaces 120, bus 125, network interface 135, memory controllers 130, memory devices 140, display controller 160, and display 165. Processing circuits 102 and 110 are representative of any number of processing circuits which are included in computing system 100. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on a same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

In an implementation, the processing circuit 110 is a general-purpose central processing unit (CPU). In one implementation, processing circuit 102 is a parallel data processing circuit with a highly parallel data microarchitecture, such as a graphics processing unit (GPU). The processing circuit 102 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In various implementations, processing circuit 102 includes multiple compute circuits 104A-104N, each including similar circuitry and components such as the multiple, parallel computational lanes 106. In some implementations, the processing circuit 102 includes one or more a single instruction multiple data (SIMD) circuits with each including the multiple, parallel computational lanes 106. Additionally, each of the compute circuits 104A-104N includes components that are not shown such as a dispatch circuit, a control circuit, one or more caches, a vector register file, and so forth. In some implementations, the parallel computational lanes 106 (or parallel execution lanes 106 or lanes 106) operate in lockstep. In various implementations, the data flow within each of the lanes 106 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across lanes 106 includes the same circuitry and functionality, and operates on a same instruction, but different data associated with a different thread. A particular combination of the same instruction and a particular data item of multiple data items is referred to as a “work item.” A work item is also referred to as a thread.

The multiple work items (or multiple threads) are grouped into thread groups, where a “thread group” is a partition of work executed in an atomic manner. In some implementations, a thread group includes instructions of a function call that operate on multiple data items concurrently. Each data item is processed independently of other data items, but the same sequence of operations of the subroutine is used. As used herein, a “thread group” is also referred to as a “work block” or a “wavefront.” Tasks performed by the parallel data processing circuit 102 can be grouped into a “workgroup” that includes multiple thread groups (or multiple wavefronts).

In an implementation, processing circuit 102 performs video rendering on an 8-pixel by 8-pixel block of a video frame. The corresponding 64 threads are grouped into two wavefronts with each wavefront including 32 threads or 32 work items. The hardware of a SIMD circuit includes 32 parallel lanes of execution. The hardware of a scheduler (not shown) assigns workgroups to the compute circuits 104A-104N. Each of the compute circuits 104A-104N includes a dispatch circuit that includes a queue for storing multiple wavefronts before the wavefronts are dispatched to the SIMD circuits that include lanes 106. In other implementations, another number of threads and wavefronts are used based on the hardware configuration of the parallel data processing circuit 102.

Although an example of a single instruction multiple data (SIMD) micro-architecture is shown for the compute circuits 104A-104N, other types of highly parallel data micro-architectures are possible and contemplated. The high parallelism offered by the hardware of the compute circuits 104A-104N is used for real-time data processing. Examples of the real-time data processing are rendering multiple pixels, image blending, pixel shading, vertex shading, and geometry shading. In such cases, each of the data items of a wavefront is a pixel of an image. The compute circuits 104A-104N can also be used to execute other threads that require operating simultaneously with a relatively high number of different data elements (or data items). Examples of these threads are threads for scientific, medical, finance, encryption/decryption, and entertainment computations.

In one implementation, processing circuit 110 is a general-purpose processing circuit, such as a CPU, with any number of processing circuit cores (or cores) that include circuitry for executing program instructions. Memory 112 represents a local hierarchical cache memory subsystem. Memory 112 stores source data, intermediate results data, results data, and copies of data and instructions that are stored in memory devices 140. For example, memory 112 stores the application 116, which is a copy of the application 144 stored in the memory devices 140. Memory 112 also stores application 117, which is a copy of application 146 stored in memory devices 140. Processing circuit 110 is coupled to bus 125 via interface 108. Processing circuit 110 receives, via interface 108, copies of various data and instructions, such as the operating system 142, one or more device drivers, one or more applications such as application 146, and/or other data and instructions.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 160. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 144. In some implementations, application 144 is a highly parallel data application such as a video graphics application, a shader application, or other. Copies of these instructions can be stored in a memory or cache device local to processing circuit 110 and/or processing circuit 102.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network. In various implementations, the network is a cloud network that includes a wide area network (WAN) for supporting communication between multiple client devices and multiple servers where the servers provide authorized access to a variety of resources and services. The client devices include a computing system such as computing system 100. The cloud network includes a variety of types of routers, one or more firewalls for security, and one or more types of network management software applications executed by the servers.

The processing circuit 110 retrieves copies of applications 144 and 146 from the memory devices 140, and the processing circuit 110 stores these copies as applications 116 and 117 in memory 112. When the instructions of a compiler are executed by circuitry 118, circuitry 118 compiles the applications 116 and 117. When application 116 is a highly parallel data application such as a shader program, a video game, or other, as part of the compilation, circuitry 118 translates instructions of the application 116 into commands executable by the SIMD circuits of the compute circuits 104A-104N of the processing circuit 102. For example, when the instructions of the compiler are executed by the circuitry 118, the circuitry 118 uses a graphics library with its own application program interface (API) to translate function calls of the application 116 into commands particular to the compute circuits 104A-104N of the processing circuit 102. The function calls in high level languages, such as C, C++, FORTRAN, and Java and so on, are translated to commands which are later processed by the hardware in processing circuit 102.

In an implementation, application 116 stored in memory 112 is a highly parallel data application and application 117 is a utility application, which is also referred to as a “utility tool.” The utility tool 117 can also be referred to as an “overclocking tool” 117. Application 117 (or utility tool 117 or overclocking tool 117) provides a graphical user interface (GUI) that illustrates, to the user, the currently used operating settings of computing system 100. As used herein, the term “operating settings” can also be referred to as “operating parameters,” “operating settings information,” and “operating parameters information.” Examples of the operating settings (or operating parameters) of computing system 100 are the average operating temperature of processing circuit 110, the average operating temperature of processing circuit 102, the average operating temperature of memory devices 140, operating clock frequencies for one or more cores or other partitions of processing circuits 102 and 110, operating power supply voltages for one or more cores or other partitions of processing circuits 102 and 110, operating clock frequencies for one or more memory devices of memory devices 140, operating power supply voltages for one or more memory devices of memory devices 140, access timing configurations of one or more memory devices of memory devices 140, the operating voltage and the operating clock frequency of a communication fabric (or fabric or interconnect) such as interconnect 125, an indication of a coupled mode where the coupled mode specifies whether the operating clock frequency of the communication fabric is coupled with the operating clock frequencies of the memory devices 140, an indication specifying a type and version of operating system 142, and an indication specifying a type and version of one or more target applications, such as application 144, to be executed by processing circuits 102 and 110.

In some implementations, the GUI of the overclocking tool 117 includes a button for the user to select when the user desires to perform automatic overclocking. As described earlier, the term “overclocking” can also be referred to as “overclocked tuning,” and “automatic overclocked tuning.” Automatic overclocked tuning (or overclocking) does not include manual steps performed by the user of the client device other than to initiate generating the overclocking request and then to later apply one or more recommended values of operating settings provided in the received overclocking recommendation profile to the computing system 100. The recommended values increase the performance of the computing system 100 and the updated operating settings no longer utilize the manufacturer's default range of settings. However, the recommended values of the overclocking recommendation profile do not lead to system failure of any components of computing system 100 and do not require iterative steps by the user. Based on the user input and executing the instructions of the overclocking tool 117, processing circuit 110 collects one or more of operating settings and system configuration parameters, and processing circuit 110 generates an overclocking request for an overclocking recommendation profile using collected information. The collected information can be referred to as the “overclocking request parameters,” which include one or more of the operating settings of computing system 100 and the system configuration parameters of computing system 100.

Examples of the operating settings of computing system 100 were provided earlier. Examples of the system configuration parameters are provided here. As used herein, the term “system configuration” can also be referred to as “system configuration settings,” “system configuration parameters,” and “system configuration information.” Examples of system configuration parameters are a serial identification number and/or a model number of one or more of processing circuits 102 and 110, an indication specifying a number of cores or other partitions of one or more of processing circuits 102 and 110, an indication specifying an age of one or more of processing circuits 102 and 110, an indication specifying an age of one or more memory devices of memory devices 140, an indication (e.g., serial identifier, a model number) specifying the number and type of memory devices 140 used as system memory of computing system 100, an indication specifying a type of motherboard (not shown) of computing system 100, an indication specifying a type and version of operating system 142, an indication specifying a type and version of one or more target applications, such as application 144, and indicators specifying a configuration of a cooling subsystem (e.g., number and type of fans, number and type of heat sinks and/or heat pipes) of computing system 100.

In addition to the above examples of the operating settings and the system configuration parameters, the overclocking request parameters can include a variety of types of log data such as log data that contains recorded error codes or other indications of errors along with indications that specify one or more of the operating settings and one or more of the system configuration parameters used at the time that the errors occurred. Further, the overclocking request parameters can include indications of a variety of types of constraints such as a limit on an amount of power consumption, an indication that only the supplied battery provides power to computing system 100, a limit on an amount of memory usage, a limit on an amount of network bandwidth, and so on. Furthermore, the overclocking request parameters can include user preferences that can be used to provide weights to values when an algorithm is used to generate the overclocking recommendation profile. The preferences can include a ranking that prioritizes power consumption over performance, and so on.

In some implementations, a secure communication channel is established between computing system 100 that executes the overclocking tool 117 and a designated server computer (or server). In some implementations, the server is located at an organizational center. Circuitry 118 sends the overclocking request to the server via network interface 135. The server retrieves or generates the overclocking recommendation profile.

As used herein, the term “overclocking recommendation profile” can also be referred to as an “overclocked profile recommendation,” an “overclocked operating settings recommended profile,” and a “recommendation profile.” The overclocking recommendation profile is a list of recommended values of one or more of the examples of the operating settings. Additionally, the overclocking recommendation profile can include recommendations for updating one or more of the system configuration parameters to recommended parameters. For example, the overclocking recommendation profile can include indications that specify an upgraded configuration of a cooling subsystem, a different version of an operating system or application, and so forth. The overclocking recommendation profile can include another form other than a list for presenting to the user the recommended values of one or more of the examples of the operating settings and system configuration parameters. In some implementations, the overclocking recommendation profile provides a ranked list of multiple updated sets of operating settings and system configuration parameters, each targeting different ranked constraints. For example, one set prioritizes power consumption over performance, whereas another set prioritizes network bandwidth over performance and yet another set prioritizes performance over all other constraints. In various implementations, the criteria for recommended values to be stored in the overclocking recommendation profiles includes one or more of the recommended values exceed one or more manufacturer's default ranges for operating settings, provide high performance or exceed a performance threshold, satisfy constraints provided in the received overclocking request parameters, and continue to provide stability for the corresponding computing system. These recommended values are stored along with a corresponding index that is based on one or more of the overclocking request parameters.

In an implementation, the overclocking recommendation profile includes an indication that specifies the coupled mode is asserted when the operating clock frequencies of the memory devices are below a clock frequency threshold. In such cases, the operating clock frequency of the fabric (interconnect 125) is the same as the operating clock frequencies of the memory devices 140. However, the overclocking recommendation profile includes an indication that specifies the coupled mode is negated when the operating clock frequencies of the memory devices 140 are greater than or equal to the clock frequency threshold. In such cases, the operating clock frequency of the fabric (interconnect 125) is less than the operating clock frequencies of the memory devices 140. In an implementation, the operating clock frequency of the fabric is one half of the operating clock frequencies of the memory devices 140. In some implementations, the use of the coupled mode in the overclocking recommendation profile provides system stability of computing system 100 while increasing performance.

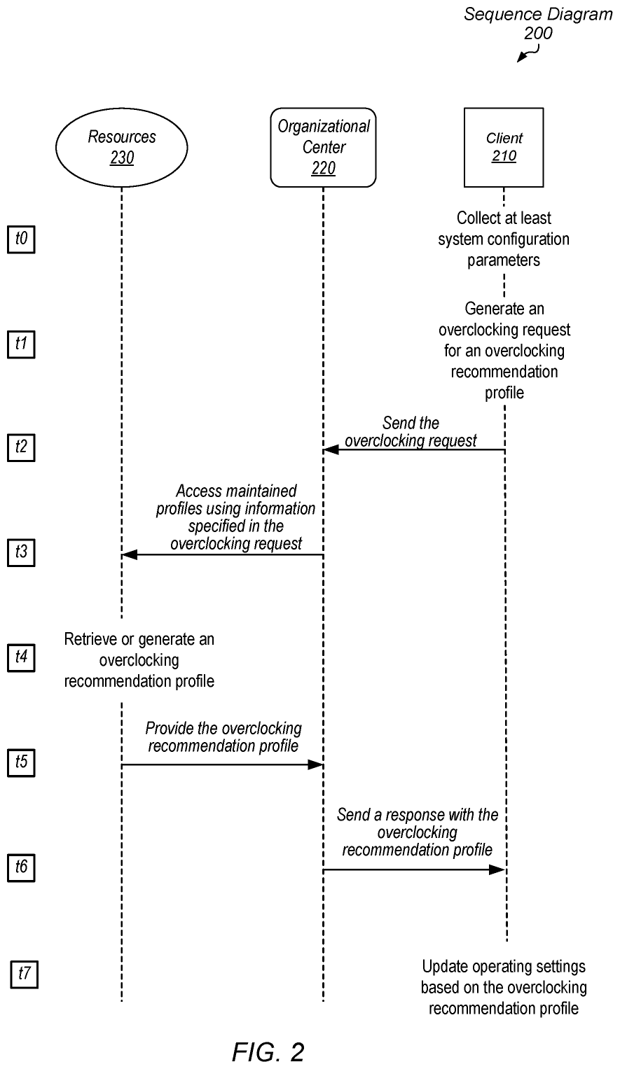

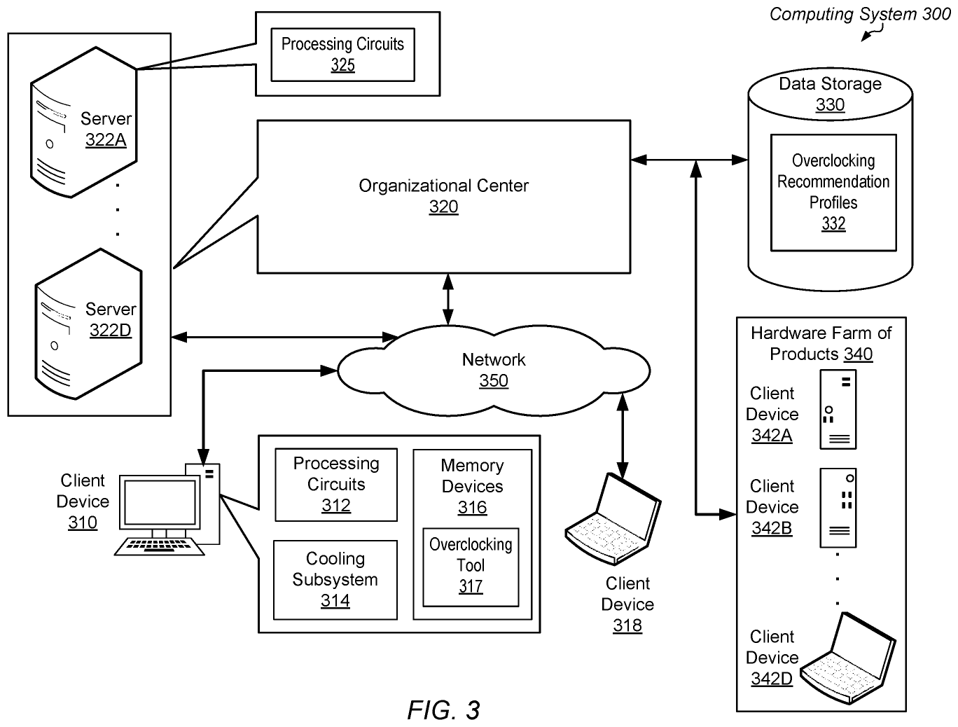

In various implementations, the server or other type of external computing device provides the overclocking recommendation profile to computing system 100 via network interface 135. In some implementations, the external computing device generates the overclocking recommendation profile, whereas in other implementations, the external computing device sends a request to another computing device that generates the overclocking recommendation profile and then returns the generated results. The steps of generating the overclocking recommendation profile can include accessing stored data, such as a database, performing simulations using system configuration parameters of the computing system 100, executing a machine learning data model, such as one of a variety of types of a neural network, and so forth. In some implementations, the external computing device is used within an external organizational center. In other implementations, the external computing device is a cloud-based server. In an implementation, the external computing device is a server or other computing system with a field programmable gate array (FPGA) that generates the overclocking recommendation profile. Further details of the generation of the overclocking recommendation profile are provided in the description of the sequence diagram 200 (of FIG. 2) and the computing system 300 (of FIG. 3).

Circuitry 118 receives, via network interface 135, the overclocking recommendation profile. The GUI of the overclocking tool 117 presents the overclocking recommendation profile to the user. The user decides which, if not all, of the operating settings to use that are provided in the overclocking recommendation profile. In an implementation, the user performs tuning of multiple operating settings of computing system 100 to increase the performance of computing system 100 such that these operating settings no longer utilize the manufacturer's default range of settings. However, the values of the overclocking recommendation profile do not lead to system failure of any components of computing system 100 and do not require iterative steps by the user. Further details of these steps are provided in the description of the sequence diagram 200 (of FIG. 2) and the computing system 300 (of FIG. 3).

Referring now to FIG. 2, a generalized diagram is shown of a sequence diagram 200 that efficiently increases computing system performance by using operating settings that exceed the manufacturer's default range of settings. A sequence of steps occurs over time between a client device 210, an organizational center 220, and resources 230. The client device 210 is one of a variety of types of client devices such as a desktop computer, a laptop computer, or otherwise. In various implementations, client device 210 includes at least the circuitry and functionality of computing system 100. In various implementations, the organizational center 220 is an infrastructure for a vendor producing one or more hardware products and software products. The organizational center 220 includes a variety of server types such as database servers, computing servers, application servers, file servers, and so on. These servers provide data and services for the client device 210, and in some implementations, the servers of the organizational center 220 and the client device 210 operate with a client-server architectural model.

In some implementations, resources 230 includes an external computing device used to retrieve or generate an overclocking recommendation profile. The external computing device is capable of accessing stored data, such as a database, and capable of communicating with other computing devices to retrieve or generate the overclocking recommendation profile. In various implementations, resources 230 are accessible only by the organizational center 220 for updating information, whereas client device 210 is able to read data stored by resources 230 and being provided by resources 230 after successful authorization. To increase the performance of the client device 210, the user attempts to tune multiple operating settings of client device 210 such that these settings no longer utilize the manufacturer's default range of settings. These operating settings are included in the recommended operating settings inserted in an overclocking recommendation profile.

At the point-in-time t0 (or time t0), client device 210 collects overclocking request parameters based on an indication from a utility tool (an overclocking tool) with instructions executed by the circuitry of client device 210. As described earlier, the overclocking request parameters include one or more of operating settings and system configuration parameters of client device 210. In some implementations, the overclocking tool is a software product already shipped with client device 210. In other implementations, the user downloads a copy of the overclocking tool from a remote server and stores the copy in system memory of client device 210. The indication specifies that the user requests to increase the performance of client device 210 by performing overclocking. For example, the indication specifies the user desires to perform automatic overclocked tuning of client device 210. In an implementation, the user selects a button on a GUI of the overclocking tool to request overclocking. In another implementation, client device 210 collects overclocking request parameters based on a request from the organizational center 220. In yet another implementation, client device 210 collects overclocking request parameters based on an automatic process used to make one or more of operating settings and system configuration parameters readily available.

After collecting the overclocking request parameters, at time t1, when executing the instructions of the overclocking tool, client device 210 generates an overclocking request for an overclocking recommendation profile. The overclocking request includes the collected overclocking request parameters. A secure communication channel is established between client device 210 and a designated server at the organizational center 220. To provide the secure communication channel, the user provides credentials when prompted, or a token authentication process is performed, or another process is used. At time t2, client device 210 sends the overclocking request to the organizational center 220.

At time t3, the server at the organizational center generates an index based on the collected overclocking request parameters. The server parses the overclocking request to use the overclocking request parameters for the index. As described earlier, the overclocking request parameters includes values of one or more operating settings, system configuration parameters of client device 210, a variety of types of log data, and indications of a variety of types of constraints. At time t4, the server searches, using the generated index, stored data such as a database. In some implementations, resources 230 includes the database. In other implementations, the organizational center 220 includes the database. Entries of the database store recommended values of an overclocking recommendation profile. Examples of these recommended values were provided earlier regarding the description of overclocking tool 117 of computing system 100 (of FIG. 1). If the response indicates a match was found for the index, then at time t5, the server retrieves the corresponding overclocking recommendation profile. In an implementation, resources 230 includes the database and resources 230 sends a response to the server of organizational center 220 that includes the corresponding overclocking recommendation profile.

In some implementations, when the server searches the database, the server searches system configuration parameters that match system configuration parameters of client device 210. In an implementation, the server also compares one or more of a variety of user-defined constraints with thresholds to generate a result of a match. In an example, the user defines performance above a threshold in addition to a limit of power consumption. The user can also add an upper limit of system memory knowing that the user is willing to install more memory devices, if necessary. A variety of types of constraints, combinations of constraints set by the user, and priority levels of the constraints set by the user and included in the overclocking request parameters are possible and contemplated. At time t4, if the response indicates no match was found for the index and the constraints comparisons, then in an implementation, the server sends a request to another server or another computing device such as a computing device of the resources 230.

In an implementation, one or more of the server and the computing device (not shown) of resources 230 is a cloud-based server. In some implementations, the computing device includes a field programmable gate array (FPGA) that generates the overclocking recommendation profile using the overclocking request parameters. In an implementation, the other computing device is a server that determines how to route the request from the organizational center 220 to yet another server to service the overclocking request. Servicing the overclocking request can include interpolating values stored in the database by retrieving values from two or more entries of the database using the overclocking request parameters. Servicing the overclocking request can include executing simulations based on the overclocking request parameters. It is possible and contemplated that one of the organizational center 220 and resources 230 includes a server or another computing device that executes a machine learning data model, such as one of a variety of types of a neural network, to generate the overclocking recommendation profile based on the overclocking request parameters.

In some implementations, resources 230 include a database such as a Production Engineering and Operations (PEO) database that includes Function Test (FT) data and System Level Test (SLT) data for multiple different system configurations. This PEO database stores test data generated internally within the organization or vendor producing one or more hardware products and software products. Therefore, the PEO database stores overclocking recommendation profiles based on test data of different system configurations. In an implementation, resources 230 also includes a hardware farm of products. The hardware farm of products includes multiple computing systems utilizing a variety of combinations of system configurations that include hardware configurations and software configurations that execute on the hardware. In an implementation, the computing systems of the hardware farm of products utilize soft fuses, which are accessed during a boot operation to simulate similar, but different system configurations. The hardware farm of products identifies, using the overclocking request parameters, a computing system in the hardware farm of products with a system configuration similar to the system settings information of client device 210. Soft fuses that are accessed during a boot operation are set for the identified computing system to simulate the system configuration of client device 210. To simulate client device 210, the modified computing system executes applications based on algorithms selecting the applications and run times matching the target applications and usage requirements indicated by the overclocking request for client device 210.

At time t5, if resources 230 retrieves or generates the overclocking recommendation profile, then resources 230 provides the overclocking recommendation profile to the organizational center 220. One or more of resources 230 and organizational center 220 stores a copy of the overclocking recommendation profile if a copy doesn't already exist. At time t6, the organizational center 220 sends a response with the overclocking recommendation profile to client device 210. At time t7, client device 210 updates operating parameters based on the overclocking recommendation profile.

Referring to FIG. 3, a generalized diagram of another computing system 300 that efficiently increases computing system performance by using operating settings that exceed the manufacturer's default range of settings. The computing system 300 includes client devices 310 and 318, organizational center 320, data storage 330, hardware farm of products 340, and network 350. Examples of the client devices 310 and 318 are as a desktop computer, a laptop computer, or other. Although two client devices are shown, computing system 300 can support any number of client devices. Each of the client devices 310 and 318 include a network interface (not shown) supporting one or more communication protocols for data and message transfers through network 350. The servers 322A-322D process software and include hardware for supporting the organizational center 110. The organizational center 110 also communicates with the data storage 330 for storing and retrieving data.

Client device 310 includes processing circuits 312, cooling subsystem 314, and memory devices 316. Client device 310 includes other components, which are not shown for ease of illustration. For example, client device 310 includes a network interface, a display controller, input/output (I/O) interfaces, memory controllers, phased locked loops (PLLs) or other clock generating circuitry, and so forth. In various implementations, client device 310 utilizes a system-on-a-chip (SOC), whereas in other implementations, client device 310 utilizes individual dies in a system-in-package (SiP) or a multi-chip module (MCM). The cooling subsystem 314 includes one or more motorized fans such as 120 millimeter (mm) fans, 240 mm fans, 360 mm fans, or larger fans. The cooling subsystem 314 includes one of air-cooling fans, all-in-one (AIO) liquid cooling fans, and custom cooling loop fans. The liquid cooling fan subsystems are radiator subsystems. The cooling subsystem 314 can also include one or more heat pipes. Additionally, the cooling subsystem 314 can include a heat sink, although laptops and other computers that need to be sealed within a container utilize a heat spreader, rather than a heat sink, as part of the cooling subsystem 314. The cooling subsystem 314 can also include a metal cooler plate.

The processing circuits 312 can include a variety of processing circuits as described earlier. For example, in an implementation, processing circuits 312 includes at least a general-purpose processing circuit and a parallel data processing circuit. Similar to memory devices 140 (of FIG. 1), memory devices 316 are representative of any number and type of memory devices. Memory devices 316 store at least instructions of an operating system, one or more device drivers, target applications, source data and result data of the target applications, and overclocking tool 317. Although not shown, client device 318 includes similar components as client device 310. However, the system configurations of client devices 310 and 318 can be different from one another. For example, comparing client device 310 and 318, there can be a different number and types of processing circuits 312, a different configuration of the cooling subsystem 314, a different number and type of memory devices 316, a different operating system or a different version of the operating system, a different version of one or more target applications, different types of target applications, and so forth. Therefore, client devices 310 and 318 can have different system settings information.

In various implementations, the organizational center 320 is an infrastructure for a vendor producing hardware products and software products. The organizational center 320 can include an intranet network providing a private network accessible only to the organization's staff. The information and services made available by an internal network of organizational center 320 is unavailable to the general public through direct access. For example, users of client devices 310 and 318 who are not a member of the organizations' staff could not use the Internet to directly access the information stored on servers 322A-322D and data storage 330 or to directly access the services provided by the servers 322A-322D. Through user authentication, the staff members are able to access resources through the internal network of organizational center 320 to communicate with other staff members, collaborate on projects and monitor product development, update products, documents and tools stored in a centralized repository and so forth.

An external interface and network of organizational center 320 is available to the general public and allows users of client devices 310 and 318 to request an overclocking recommendation profile. The overclocking recommendation profile is used to perform tuning of multiple operating settings of client device 310 or client device 318 to increase the performance such that these operating settings no longer utilize the manufacturer's default range of settings. However, the values of the overclocking recommendation profile do not lead to system failure of any components of a corresponding one of client device 310 and client device 318. The hardware, such as circuitry, of one or more of servers 322A-322D perform steps to provide the overclocking recommendation profile to a requesting client device of client devices 310 and 318.

The external interface of organizational center 320 can include one or more push notification services for coordinating notifications and data retrieval, such as system settings information, for the client devices 310 and 318. In addition, the external interface can include application programming interfaces (APIs) used for notifications, handling a communication protocol for processing requests, and data collection or retrieval. The external interface supports an extranet network which allows customers, partners, and suppliers to securely access a selected portion of the resources available within organizational center 320. The external interface of organizational center 320 uses one or more communication protocols to allow access through the network 350. Network 350 includes multiple switches, routers, cables, wireless transmitters, one or more firewalls for security, and one or more types of network management software applications, and the Internet for transferring messages and data. Accordingly, the external interface of organizational center 320 supports at least the Hypertext Transfer Protocol (HTTP) for communication across the World Wide Web. In various implementations, network 350 is a cloud network that includes the wide area network (WAN) for supporting communication between client devices 310 and 318 and multiple servers such as servers 322A-322D and servers within the organizational center 320 providing authorized access to a variety of resources and services.

The data storage 330 includes one or more data stores supported and used by the organizational center 320. Data storage 330 stores data using one of a variety of non-volatile storage devices such as a hard disk drive (HDD) or a solid-state drive (SSD). The servers 322A-322D include a variety of server types such as database servers, computing servers, application servers, file servers, mail servers and so on. As shown, server 322A includes at least processing circuits 325. The processing circuits 325 can include a variety of processing circuits such as at least a general-purpose processing circuit and a parallel data processing circuit. Although not shown, servers 322B-322D include similar components as server 322A. In various implementations, the servers 322A-322D and the client devices 310 and 318 operate with a client-server architectural model. A given one of the servers 322A-322D can serve multiple client devices of the client devices 310 and 318, and a given client device of the client devices 310 and 318 can use multiple servers of the servers 322A-322D. In various implementations, the data transferred between the organizational center 320 and the client devices 310 and 318 includes notifications, requests, and response data.

Overclocking tool 317 provides a GUI that illustrates, to the user, the currently used operating settings of client device 310. Examples of the currently used operating settings were described earlier regarding computing system 100 (of FIG. 1). In addition, the GUI of overclocking tool 317 includes a button for the user to select when the user desires to perform automatic overclocking, which includes receiving the overclocking recommendation profile used to perform tuning of multiple operating settings of client device 310 to increase the performance of client device 310 such that these operating settings no longer utilize the manufacturer's default range of settings. However, the values of the overclocking recommendation profile do not lead to system failure of any components of client device 310 and do not require iterative steps by the user. When executing the instructions of the overclocking tool 317, one of the processing circuits 312 collects overclocking request parameters of client device 310. Examples of the overclocking request parameters were described earlier regarding computing system 100 (of FIG. 1).

After collecting the overclocking request parameters of client device 310, when executing the instructions of overclocking tool 117, one of the processing circuits 312 generates the overclocking request using the collected overclocking request parameters. A secure communication channel is established between client device 310 and a designated server of servers 322A-322D of organizational center 320. The organizational center 320 retrieves or generates the overclocking recommendation profile based on receiving the overclocking request from client device 310. In an implementation, when server 322A is the dedicated server, the circuitry of the processing circuits 325 performs steps to retrieve or generate the overclocking recommendation profile to satisfy the request from client device 310. In other implementations, multiple servers of servers 322A-322D perform steps to retrieve or generate the overclocking recommendation profile.

In an implementation, data storage 330 stores overclocking recommendation profiles 332 corresponding to multiple different system configurations. Staff members of organizational center 320 have already run different types of workloads on the multiple computing systems while varying the values of the currently used operating settings. Operating settings that satisfy criteria are stored as recommended operating settings in the overclocking recommendation profiles 332. Examples of the information stored in the overclocking recommendation profiles 332 were described earlier regarding computing system 100 (of FIG. 1). In various implementations, the criteria for recommended values to be stored in the overclocking recommendation profiles 332 includes one or more of the recommended values exceed one or more manufacturer's default ranges for operating settings, provide high performance or exceed a performance threshold, satisfy constraints provided by users in the received overclocking request parameters, and continue to provide stability for the corresponding computing system. These recommended values of the overclocking recommendation profiles 332 are stored along with a corresponding index generated from values provided in the overclocking request parameters.

One of the servers 322A-322D searches the overclocking recommendation profiles 332 using an index generated from the system settings information of client device 310, which is parsed from the overclocking request. For the generated index, if the server finds an overclocking recommendation profile in the overclocking recommendation profiles 332, then the server retrieves this overclocking recommendation profile and sends the overclocking recommendation profile to client device 310. In an implementation, the organizational center 320 maintains the overclocking recommendation profiles 332 as a Production Engineering and Operations (PEO) database that includes Function Test (FT) data and System Level Test (SLT) data for multiple different system configurations. In other implementations, a variety of other types of databases are maintained.

For the generated index, if the server of servers 322A-322D does not find an overclocking recommendation profile in the overclocking recommendation profiles 332, then the server retrieves or generates an overclocking recommendation profile. As described earlier, finding a match includes performing steps such as comparing values of an index and comparing one or more constraints with thresholds. In various implementations, the servers 322A-322D have the same functionality as one or more of resources 230 and organizational center 220 (of FIG. 2). Therefore, servers 322A-322D perform one or more steps to retrieve or generate the requested overclocking recommendation profile. In some implementations, a server of servers 322A-322D or another computing device of organizational center 320 includes a field programmable gate array (FPGA) that generates the overclocking recommendation profile using the overclocking request parameters.

In other implementations, the server of servers 322A-322D sends a request to the hardware farm of products 340 to identify, using the index, a computing system of client devices 342A-342D with a system configuration similar to the system configuration parameters of client device 310. Staff members of the organizational center 320 set soft fuses that are accessed during a boot operation for the identified client device of client devices 342A-342D. By setting the soft fuses in a particular manner, the identified client device of client devices 342A-342D can be used to simulate a client device with configuration settings similar to the system configuration parameters of client device 310. The modified identified client device of client devices 342A-342D executes applications based on algorithms selecting the applications and run times matching the target applications and usage requirements indicated by the overclocking request for client device 310.

The hardware farm of products 340 provides a response to the server of servers 322A-322D that includes simulation data collected during the execution of applications on the modified identified client device of client devices 342A-342D. Staff members of the organizational center 320 or the server select optimized tunable settings that satisfy the usage requirements indicated by the overclocking request parameters for client device 310. The server updates the overclocking recommendation profile 332 with this generated overclocking recommendation profile.

In yet another implementation, for the generated index, if the server of servers 322A-322D does not find an overclocking recommendation profile in the overclocking recommendation profiles 332, then the server executes a machine learning data model, such as one of a variety of types of a neural network, to generate the overclocking recommendation profile based on the overclocking request parameters. A server of servers 322A-322D sends, via network 350, the retrieved or generated overclocking recommendation profile to client device 310. The GUI of the overclocking tool 317 presents the overclocking recommendation profile to the user. The user decides which, if not all, of the recommended values to use that are provided in the overclocking recommendation profile.

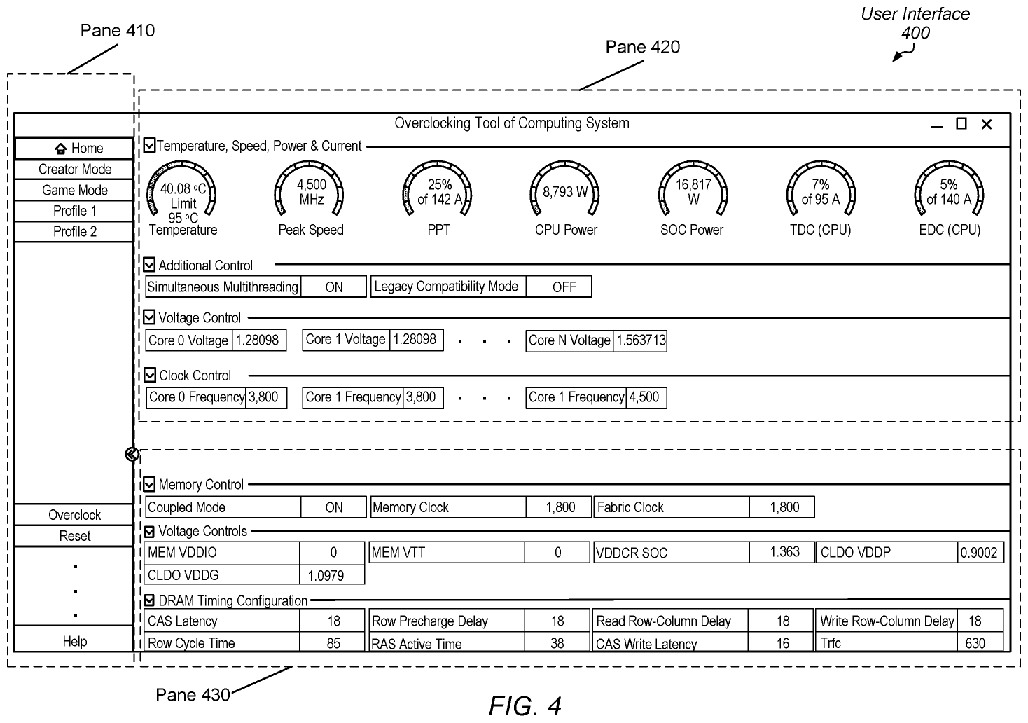

Turning now to FIG. 4, a generalized block diagram is shown of a user interface 400 of an overclocking tool used for efficiently increasing computing system performance by using operating settings that exceed the manufacturer's default range of settings. User interface 400 is provided as a graphical user interface (GUI). In various implementations, the user interface 400 is presented on a display device of a user's computing device (or client device) when the user launches the overclocking tool. As shown, user interface 400 includes a particular number and type of panes, boxes, and buttons. However, in other implementations, user interface 400 includes other numbers and types of panes, boxes, and buttons. For example, in other implementations, user interface 400 includes other types of buttons, drop-down menus, and so on that either show information in another manner (e.g., a pie chart, a bar graph, a three-dimensional figure, etc.) or provide other types of functionalities. It is also noted that the information provided in the display of user interface 400 changes as the user selects menu options and buttons on a currently presented window of user interface 400. Circuitry of a processing circuit executes instructions of the overclocking tool, and during execution, the processing circuit sends updates to the display controller to provide updates to the view of user interface 400.

In the illustrated implementation, user interface 400 includes panes 410, 420 and 430. Although panes 410, 420 and 430 show particular types of fields and a particular arrangement of the fields within them, it is possible and contemplated that panes 410, 420 and 430 show a variety of other types of fields and use other arrangements. Pane 410 provides multiple buttons that offer selections for the user. Examples of the selections are a “Home” button to return to a home page of the overclocking tool, and one or more mode buttons with each mode button corresponding to a particular preconfigured operating settings profile. Similar to the overclocking recommendation profile provided by an overclocking request, each of these preconfigured operating settings profiles includes one or more of operating voltages (power supply voltages) and clock frequencies of the cores or other partitions of processing circuits, recommended operating voltage (power supply voltage) and clock frequency of memory devices, and access timing configuration of the memory devices 140. A “Game Mode” typically includes higher performance operating settings than operating settings of other modes.

The “Reset” button can provide a default operating settings profile. Any additions to the operating settings can be stored with selection of an “Update” button (not shown), and any additions or modifications are removed with selection of a “Clear” button (not shown). The “Help” button can provide a search function for questions and topics that lead to the overclocking tool loading a particular page of information or a Web link. The “Overclock” button initiates an overclocking operation. The “Overclock” button allows the user to select when the user desires to perform automatic overclocking, which includes receiving the overclocking recommendation profile used to perform tuning of multiple operating settings of the user's client device to increase the performance of the client device such that these operating settings no longer utilize the manufacturer's default range of settings or any of the operating settings profiles corresponding to the mode buttons. However, the values of the overclocking recommendation profile do not lead to system failure of any components of the client device and do not require iterative steps by the user.

Panes 420 and 430 provide the user with a view of presently used values of different operating parameters. For purposes of discussion, sample values are shown in panes 420 and 430 for illustrative purposes. Other values are possible and are contemplated. Further, additional data can be maintained for each field shown in panes 420 and 430. Pane 420 includes the presently achieved operating temperature of one of a particular processing circuit, the system on a chip (SoC), the motherboard, or otherwise. The temperature limit is also shown. Pane 420 also includes one or more of a peak achieved operating clock frequency of the multiple cores or other partitions of processing circuits, a package power tracking (PPT) threshold of a socket on the motherboard measured in watts or an amount of current drawn by the socket, a measurement of power consumption of a particular processing circuit (such as the CPU), a measurement of power consumption of the SoC, a measurement of CPU consumption of motherboard power supply Thermal Design Current (TDC) capacity, and a measurement of CPU consumption of motherboard power supply Electrical Design Current (EDC) capacity.

Pane 420 also includes settings that indicate whether simultaneous multithreading is enabled and whether legacy compatibility mode is enabled. This mode disables some of the cores of a processing circuit (e.g., CPU) to provide compatibility with some applications that do not behave well with high core counts. Pane 420 also includes settings that indicate the presently used operating power supply voltages of cores or other partitions of processing circuits, and presently used operating clock frequencies of cores or other partitions of processing circuits. Pane 430 includes settings that indicate whether coupled mode is enabled. The coupled mode indicates whether the communication fabric (or fabric) operating clock frequency is coupled with the operating clock frequencies of the memory devices. Pane 430 includes settings that indicate the operating clock frequencies of the fabric and the memory devices, the operating power supply voltages of the memory devices, and the access time configuration of the memory devices.

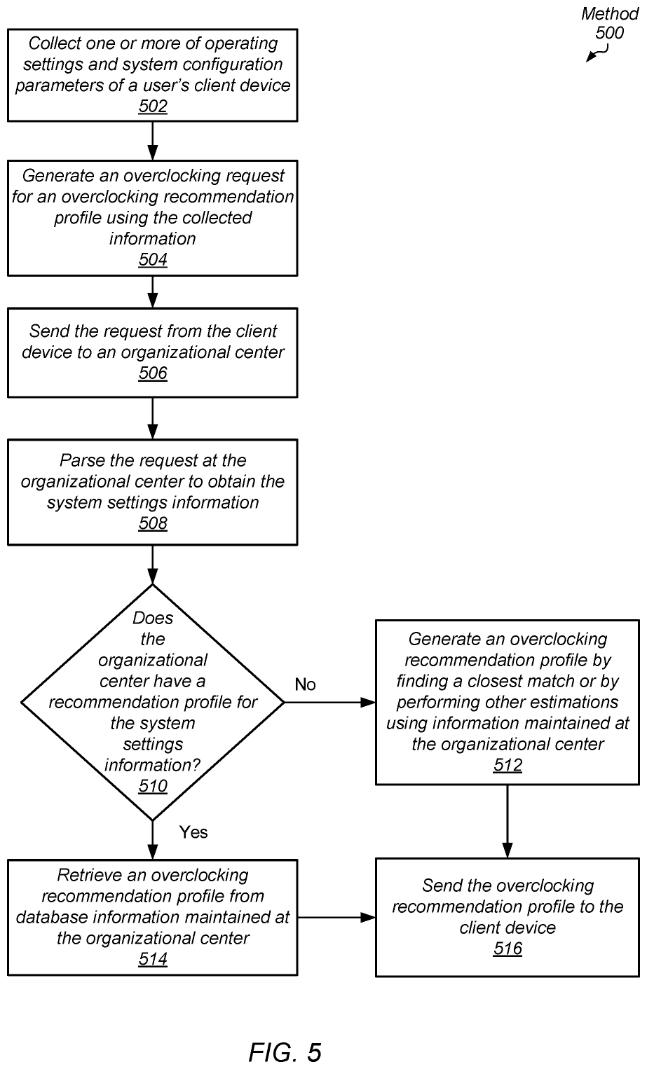

Regarding the methods 500-900 (of FIGS. 5-9), a computing system includes at least a first processing circuit and a second processing circuit for processing tasks of a workload. The computing system also includes one or more memory devices for storing a variety of types of data in system memory, a cooling system for management of power consumption, and a network interface. In some implementations, the first processing circuit has a general-purpose microarchitecture, and the second processing circuit is a parallel data processing circuit with a highly parallel data microarchitecture. The memory devices receive data and provide data based on an access time configuration. The access time configuration includes voltage levels, clock frequencies and durations of time measured in clock cycles for one or more transactions. When the memory devices are DRAM devices, examples of these transactions are an activation (opening) transaction, a column access transaction, a read access transaction, a write access transaction, and a precharge (closing) transaction. A user's client device includes the computing system. Examples of the client device are a desktop computer, a laptop computer, or otherwise. The user desires to increase the performance of the client device by using operating settings that exceed the manufacturer's default range of settings. Selecting the operating settings should remove manual iterative steps and provide operating settings that will not cause system failure.

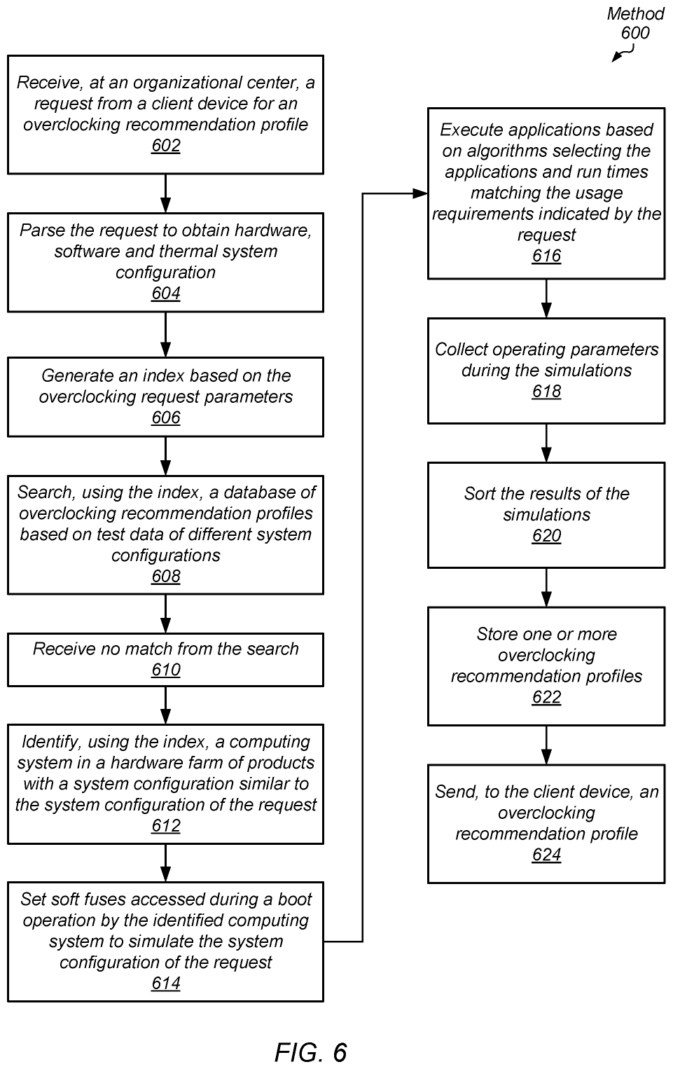

Referring to FIG. 5, a generalized block diagram is shown of a method 500 for efficiently increasing computing system performance by using operating settings that exceed the manufacturer's default range of settings. For purposes of discussion, the steps in this implementation (as well as FIGS. 6-9) are shown in sequential order. However, in other implementations some steps occur in a different order than shown, some steps are performed concurrently, some steps are combined with other steps, and some steps are absent.

When executing the instructions of an application, such as a utility tool (or overclocking tool), circuitry of the first processing circuit collects one or more of operating settings and system configuration parameters of the user's client device (block 502). In some implementations, the GUI of the overclocking tool includes a button for the user to select when the user desires to perform automatic overclocking. Automatic overclocking requests the overclocking recommendation profile, which is used to perform tuning of multiple operating settings of the user's client device to increase the performance of the client device such that these operating settings no longer utilize the manufacturer's default range of settings. However, the recommended values of the overclocking recommendation profile do not lead to system failure of any components of the client device and do not require iterative steps by the user. Based on user input, the first processing circuit generates an overclocking request for an overclocking recommendation profile using the collected information (block 504). The collected information can be referred to as the “overclocking request parameters,” which include one or more of the operating settings of the user's client device and the system configuration parameters of the user's client device.

As described earlier, the term “operating settings” can also be referred to as “operating parameters,” “operating settings information,” and “operating parameters information.” Examples of the operating settings (or operating parameters) of the user's client device (a user's computing system) are the average operating temperatures of one or more processing circuits, the average operating temperature of memory devices, the operating voltages and the operating clock frequencies of one or more cores of a general-purpose processing circuit, the operating voltages and the operating clock frequencies of one or more compute circuits or other subblocks of a parallel data processing circuit, the operating voltages and the operating clock frequencies of one or more memory devices of the memory subsystem, the access timing configurations of the one or more memory devices, the operating voltage and the operating clock frequency of a communication fabric (or fabric or interconnect), an indication of a coupled mode where the coupled mode specifies whether the operating clock frequency of the communication fabric is coupled with the operating clock frequencies of the memory devices, an indication specifying a type and version of an operating system, and an indication specifying a type and version of one or more target applications to be executed by processing circuits of the user's client device.

As described earlier, the term “system configuration” can also be referred to as “system configuration settings,” “system configuration parameters,” and “system configuration information.” Examples of system configuration parameters are a serial identification number and/or a model number of one or more processing circuits (e.g., CPU, GPU, FPGA, ASIC), an indication specifying a number of cores or other partitions of one or more processing circuits, an indication specifying an age of one or more processing circuits, an indication specifying an age of one or more memory devices, an indication (e.g., serial identifier, a model number) specifying the number and type of memory devices used as system memory of the user's client device, an indication specifying a type of motherboard of the user's client device, an indication specifying a type and version of an operating system executed by the user's client device, an indication specifying a type and version of one or more target applications to be executed on the user's client device, and indicators specifying a configuration of a cooling subsystem (e.g., number and type of fans, number and type of heat sinks and/or heat pipes).

The first processing circuit sends the overclocking request from the client device to an organizational center (block 506). In various implementations, a secure communication channel is established between the user's client device and a designated server at the organizational center. The server parses the request at the organizational center to obtain the overclocking request parameters, which includes one or more of the above examples of the operating settings of the user's client device and the system configuration parameters of the user's client device (block 508). In addition to the operating settings and the system configuration parameters, the overclocking request parameters can include log data that contains recorded error codes or other indications of errors along with indications that specify one or more of the operating settings and one or more of the system configuration parameters used at the time that the errors occurred. Further, the overclocking request parameters can include indications of constraints such as a limit on an amount of power consumption, an indication that only the supplied battery provides power to the user's client device, a limit on an amount of memory usage, a limit on an amount of network bandwidth, and so on. Furthermore, the overclocking request parameters can include user preferences that can be used to provide weights to values when an algorithm is used to generate the overclocking recommendation profile. The preferences can include a ranking that prioritizes power consumption over performance, and so on. In an implementation, the server generates an index based on one or more values of the overclocking request parameters. The server searches, using the index, a PEO database of the organizational center. The PEO database stores overclocking recommendation profiles based on test data of different system configurations.

If the organizational center does not have an overclocking recommendation profile for the system configuration of the user's client device (“no” branch of the conditional block 510), then one or more other servers generate an overclocking recommendation profile by finding a closest match or by performing other estimations using information maintained at the organizational center (block 512). Further details of estimating the overclocking recommendation profile are provided in the description of method 600 (of FIG. 6). Afterward, a server at the organizational center sends the overclocking recommendation profile to the client device (block 516).

As described earlier, the term “overclocking recommendation profile” can also be referred to as an “overclocked profile recommendation,” an “overclocked operating settings recommended profile,” and a “recommendation profile.” The overclocking recommendation profile is a list of recommended values of one or more of the examples of the operating settings. Additionally, the overclocking recommendation profile can include recommendations for updating one or more of the system configuration parameters to recommended parameters. For example, the overclocking recommendation profile can include indications that specify an upgraded configuration of a cooling subsystem, a different version of an operating system or application, and so forth. The overclocking recommendation profile can include another form other than a list for presenting to the user the recommended values of one or more of the examples of the operating settings and system configuration parameters. In some implementations, the overclocking recommendation profile provides a ranked list of multiple updated sets of operating settings and system configuration parameters, each targeting different ranked constraints. For example, one set prioritizes power consumption over performance, whereas another set prioritizes network bandwidth over performance and yet another set prioritizes performance over all other constraints. In various implementations, the criteria for recommended values to be stored in the overclocking recommendation profiles includes one or more of the recommended values exceed one or more manufacturer's default ranges for operating settings, provide high performance or exceed a performance threshold, satisfy constraints provided in the received overclocking request parameters, and continue to provide stability for the corresponding computing system. These recommended values are stored along with a corresponding index that is based on one or more of the overclocking request parameters.

In some implementations, the server inserts an indication in the response specifying a source of the information found in the overclocking recommendation profile. For example, the indication specifies whether the overclocking recommendation profile was generated by finding a match in the PEO database or was generated by running simulations on a hardware-based system or a software-based system simulating the hardware and/or software resources of the user's client device, or by performing other estimations using information maintained at the organizational center. If the organizational center has an overclocking recommendation profile for the system configuration of the user's client device (“yes” branch of the conditional block 510), then the server retrieves an overclocking recommendation profile from database information maintained at the organizational center (block 514). Afterward, control flow of method 500 moves to block 516 where organizational center sends the overclocking recommendation profile to the client device.

Turning now to FIG. 6, a generalized block diagram is shown of a method 600 for efficiently increasing computing system performance by using operating settings that exceed the manufacturer's default range of settings. A dedicated server, at an organizational center, receives an overclocking request from the client device for an overclocking recommendation profile (block 602). The server parses the request to obtain hardware, software, and thermal system configuration (block 604). These values are found in the overclocking request parameters collected at the user's client device and sent with the overclocking request. The server generates an index based on the overclocking request parameters (block 606). The server searches, using the index, a database of operating parameters recommendation profiles based on test data of different system configurations (block 608).

The server receives an indication specifying no match from the search (block 610). The server identifies, using one or more of the index and the overclocking request parameters, a computing system in a hardware farm of products (block 612). In some implementations, one or more thresholds are used to select the system configuration to use for simulations. The thresholds can include differences with one or more of the values of the system configuration parameters or a range of acceptable values of the system configuration parameters. Examples the selection criteria are a range of serial identifiers or model numbers of one or more processing circuits, which indirectly provides a range of operating parameters provided by the processing circuits, a range of serial identifiers or model numbers of memory devices, a range of an amount of data storage provided by the memory devices, a range of version numbers of an operating system and a target application, and so forth.

One or more of a member of the staff at the organizational center or a software application run on a server at the organizational center sets soft fuses on the computing system. The soft fuses are accessed during a boot operation by the identified computing system to simulate the system configuration of the request (the system configuration of the user's client device) (block 614). One or more of a member of the staff at the organizational center or a software application executes applications based on algorithms selecting the applications and run times matching the usage requirements indicated by the request (block 616). Although these steps include the use of a hardware farm of products, in other implementations, generating an overclocking recommendation profile with simulations includes a software-based simulation system capable of simulating a variety of types of system configurations. In some implementations, a server or another computing device executes a machine learning data model, such as one of a variety of types of a neural network, to generate the overclocking recommendation profile based on the overclocking request parameters. In other implementations, the server or another computing device includes a field programmable gate array (FPGA) that generates the overclocking recommendation profile using the overclocking request parameters.

At the organizational center, operating parameters and other monitored result data are collected during the simulations (block 618). A software application executed by a server or another type of computing device sorts the results of the simulations (block 620). Sorting is based on a variety of types of criteria. The criteria can include constraints provided in the overclocking request parameters of the overclocking request. The criteria can include other constraints generated by the software application to generate other overclocking recommendation profiles.

In an implementation, the user added to the overclocking request parameters indications of the highest amount of performance that can be achieved with a specified limit of power consumption. These criteria are used to generate an overclocking recommendation profile to service the overclocking request. Other criteria not included in the overclocking request parameters can include the highest amount of performance that can be achieved with a specified limit of an amount of memory or a specified limit of available network bandwidth. These criteria can be used to generate other overclocking recommendation profiles. A server or other computing device stores the one or more generated overclocking recommendation profiles (block 622). A server at the organizational center sends, to the client device, the overclocking recommendation profile that satisfies constraints provided in the overclocking request parameters of the overclocking request (block 624).

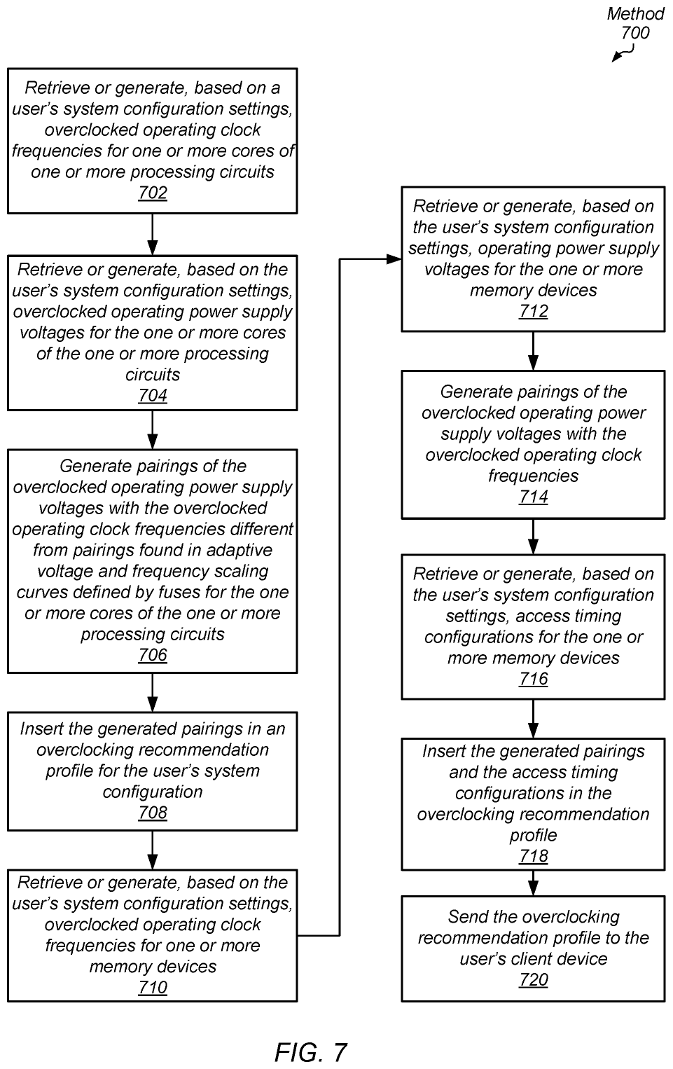

Referring to FIG. 7, a generalized block diagram is shown of a method 700 for efficiently increasing computing system performance by using operating settings that exceed the manufacturer's default range of settings. Servers at the organizational center retrieve or generate, based on a user's system configuration settings, overclocked operating clock frequencies for one or more cores or other partitions of one or more processing circuits (block 702). To retrieve the overclocked operating clock frequencies, a server at the organizational center searches a PEO database based on an index generated from the system settings information of the user's client device, and the server finds a match in the PEO database. In an implementation, to generate the overclocked operating clock frequencies, the server simulates the user's client device by programming soft fuses of a computing system in a hardware farm of products at the organizational center. In another implementation, to generate the overclocked operating clock frequencies, the server utilizes a machine learning data model that generates a database using a closest match found in the PEO database and the modified computing system of the hardware farm of products. The machine learning data model generates inferences or predictions of how much particular operating settings affect overclocking the user's client device.

The server retrieves or generates, based on the user's system configuration settings, overclocked operating power supply voltages for the one or more cores or other partitions of the one or more processing circuits (block 704). The server generates pairings of the overclocked operating power supply voltages with the overclocked operating clock frequencies different from pairings found in adaptive voltage and frequency scaling curves defined by fuses for the one or more cores or other partitions of the one or more processing circuits (block 706). The server inserts the generated pairings in an overclocking recommendation profile for the user's system configuration (block 708).

The server retrieves or generates, based on the user's system configuration settings, overclocked operating clock frequencies for one or more memory devices (block 710). The server retrieves or generates, based on the user's system configuration settings, operating power supply voltages for the one or more memory devices (block 712). The server generates pairings of the overclocked operating power supply voltages with the overclocked operating clock frequencies (block 714). The server retrieves or generates, based on the user's system configuration settings, access timing configurations for the one or more memory devices (block 716). The access time configuration includes voltage levels, clock frequencies and durations of time measured in clock cycles for one or more transactions. When the memory devices are DRAM devices, examples of these transactions are an activation (opening) transaction, a column access transaction, a read access transaction, a write access transaction, and a precharge (closing) transaction. It is noted that in some implementations, selection of the above system configuration settings is further based on the configuration of a cooling subsystem used by the user's client device and the type of motherboard of the user's client device. The server inserts the generated pairings and the access timing configurations in the overclocking recommendation profile (block 718). The server at the organizational center sends the overclocking recommendation profile to the user's client device (block 720).

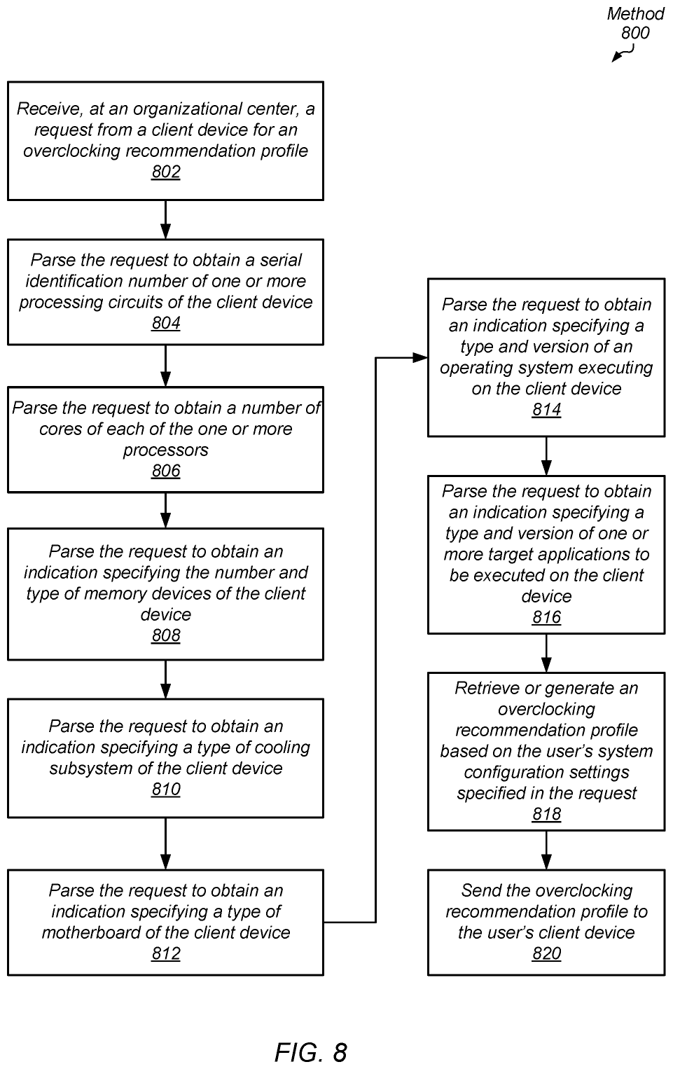

Turning now to FIG. 8, a generalized block diagram is shown of a method 800 for efficiently increasing computing system performance by using operating settings that exceed the manufacturer's default range of settings. A server at an organizational center receives a request from a client device for an overclocking recommendation profile (block 802). The server parses the request to obtain a serial identification number of one or more processing circuits of the client device (block 804). The server parses the request to obtain a number of cores of each of the one or more processing circuits (block 806). The server parses the request to obtain an indication specifying the number and type of memory devices of the client device (block 808).

The server parses the request to obtain an indication specifying a type of cooling subsystem of the client device (block 810). In some implementations, the cooling subsystem includes one or more motorized fans such as 120 mm fans, 240 mm fans, 360 mm fans, or larger fans. The cooling subsystem includes one of air-cooling fans, all-in-one (AIO) liquid cooling fans, and custom cooling loop fans. The liquid cooling fan subsystems are radiator subsystems. The cooling subsystem can also include one or more heat pipes. Additionally, the cooling subsystem can include a heat sink, although laptops and other computers that need to be sealed within a container, utilize a heat spreader, rather than a heat sink, as part of the cooling subsystem. The cooling subsystem can also include a metal cooler plate. The server parses the request to obtain an indication specifying a type of motherboard of the client device (block 812). The server parses the request to obtain an indication specifying a type and version of an operating system executing on the client device (block 814). The server parses the request to obtain an indication specifying a type and version of one or more target applications to be executed on the client device (block 816). The server retrieves or generates an overclocking recommendation profile based on the user's system configuration settings specified in the request (block 818). The server at the organizational center sends the overclocking recommendation profile to the user's client device (block 820).

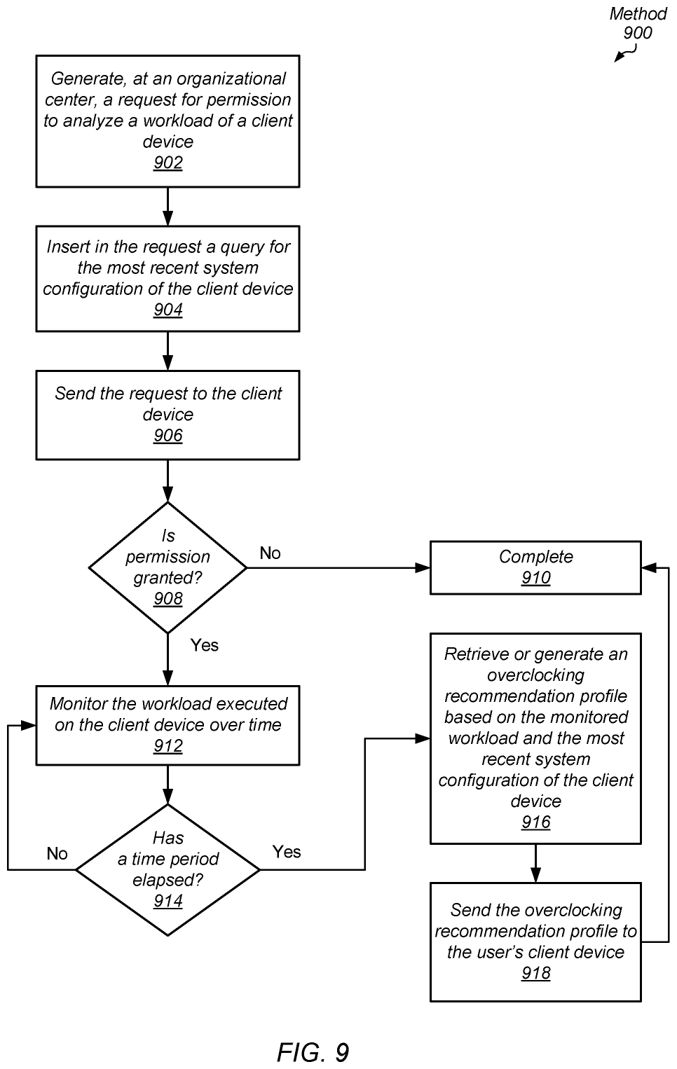

Referring to FIG. 9, a generalized block diagram is shown of a method 900 for efficiently increasing computing system performance by using operating settings that exceed the manufacturer's default range of settings. A server at the organizational center generates a request for permission to analyze the workload of a client device (block 902). The server inserts in the request a query for the most recent system configuration of the client device (block 904). The server sends the request to the client device (block 906). If permission is not granted (“no” branch of the conditional block 908), then the process to provide the overclocking recommendation profile to the user's client device completes (block 910). An indication of the denial of the request is sent from the client device to the server. In some implementations, no overclocking recommendation profile is generated and provided to the user's client device. In other implementations, the server sends one or more overclocking recommendation profiles to the user's client device as suggested overclocked settings. The server also sends an indication specifying that finer tuning is available if the system configuration parameters of the user's client device are provided to the organizational center.

If permission is granted (“yes” branch of the conditional block 908), then the server at the organizational center monitors the workload executed on the client device over time (block 912). A secure communication channel is established between the user's client device and a designated server at the organizational center. To provide the secure communication channel, the user provides credentials when prompted, or a token authentication process is performed, or another process is used. A time period is stored in a programmable configuration register at the organizational center. If the time period has not elapsed (“no” branch of the conditional block 914), then control flow of method 900 returns to block 912 where the server monitors the workload executed on the client device over time. If the time period has elapsed (“yes” branch of the conditional block 914), then the server retrieves or generates an overclocking recommendation profile based on the monitored workload and the most recent system configuration of the client device (block 916). The server sends the overclocking recommendation profile to the user's client device (block 918). Afterward control flow of method 900 moves to block 910 where the process to provide the overclocking recommendation profile to the user's client device completes.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer.

For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A system comprising:
a network interface; and
circuitry configured to:
receive an overclocking request from a client device via the network interface;
generate a response to the overclocking request, wherein the response includes an operating settings recommendation profile; and
send the response to the client device via the network interface.

2. The system as recited in claim 1, wherein the overclocking request comprises system configuration information of the client device.

3. The system as recited in claim 2, wherein the system configuration information comprises a plurality of parameters including information that identifies one or more of an identification of one or more components of the client device, a type of cooling system of the client device, and a type of memory device of the client device.

4. The system as recited in claim 1, wherein the operating settings recommendation profile comprises settings that exceed recommended settings for one or more components of the client device.

5. The system as recited in claim 1, wherein the circuitry is configured to retrieve the operating settings recommendation profile from a database comprising a plurality of operating settings recommendation profiles.

6. The system as recited in claim 1, wherein the circuitry is further configured to:
generate an index based on information included in the overclocking request; and
retrieve the operating settings recommendation profile by accessing a database with the index.

7. The system as recited in claim 1, wherein responsive to receipt of the overclocking request, the circuitry is configured to generate the operating settings recommendation profile based on one or more simulations.

8. A method comprising:
receiving an overclocking request from a client device via a network interface;
generating a response to the overclocking request, wherein the response includes an operating settings recommendation profile; and
sending the response to the client device via the network interface.

9. The method as recited in claim 8, wherein the overclocking request comprises system configuration information of the client device.

10. The method as recited in claim 9, wherein the system configuration information of the client device comprises a plurality of parameters including information that identifies one or more of an identification of one or more components of the client device, a type of cooling system of the client device, and a type of memory device of the client device.

11. The method as recited in claim 8, wherein the operating settings recommendation profile comprises settings that exceed recommended settings for one or more components of the client device.

12. The method as recited in claim 8, further comprising retrieving the operating settings recommendation profile from a database comprising a plurality of operating settings recommendation profiles.

13. The method as recited in claim 8, further comprising:
generating an index based on information included in the overclocking request; and
retrieving the operating settings recommendation profile by accessing a database with the index.

14. The method as recited in claim 8, wherein responsive to receipt of the overclocking request, the method comprises generating the operating settings recommendation profile based on one or more simulations.

15. A system comprising:
a network interface; and
circuitry configured to:
generate an overclocking request, the overclocking request including one or more configuration parameters of the system;
send the overclocking request, via the network interface, to a server comprising a plurality of overclocking recommendation profiles;
receive, from the server via the network interface, a given overclocking recommendation profile of the plurality of overclocking recommendation profiles; and
update one or more operating settings of the system based on the given overclocking recommendation profile.

16. The system as recited in claim 15, wherein the given overclocking recommendation profile comprises settings that exceed a default range of settings for the system.

17. The system as recited in claim 16, wherein the given overclocking recommendation profile comprises a recommended power supply voltage and recommended clock frequency for at least one processor in the system.

18. The system as recited in claim 16, wherein the given overclocking recommendation profile comprises a recommended power supply voltage and recommended clock frequency for at least memory device in the system.

19. The system as recited in claim 15, wherein the overclocking request comprises one or more of a serial identification number of one or more processing circuits of the system, an indication specifying a type of cooling system of the system, and an indication specifying a number and type of memory devices of the system.

20. The system as recited in claim 15, wherein the overclocking request comprises one or more of an age of one or more processing circuits of the system and log data comprising indications of errors that have occurred within the system.
